(19) United States
(12) Patent Application Publication
(10) Pub. No.: US 2007/0023724 A1
(43) Pub. Date: Feb. 1, 2007

(54) Regulator for electropneumatic pressure converters

(76) Inventors: Harald Laue, Esslingen (DE); Erwin Krimmer, Pluederhausen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/555,690

(22) PCT Filed: Mar. 17, 2004
(86) PCT No.: PCT/DE04/00532

§ 371 Date: Nov. 4, 2005

(30) Foreign Application Priority Data
May 14, 2003 (DE) 103 21 731.2

(51) Int. Cl. F16K 31/02

(52) U.S. Cl. 251/129.22

(57) ABSTRACT

An electropneumatic pressure converter including a magnet valve which has a magnet coil and a magnet core received in a housing as is a regulator unit. By means of the electropneumatic pressure converter, variable underpressures p_{VAR} of consumers can be regulated. The regulator unit has components joined together by material engagement, forming sealing points.

### FIELD OF THE INVENTION

Electropneumatic pressure converters are used in motor vehicles and make it possible to furnish a consumer pressure (consumer underpressure) that is between an ambient pressure and a predeterminable underpressure. The level of the consumer pressure is as a rule set via a control current to which a coil body of a magnet valve of the electropneumatic pressure converter is subjected. By means of electropneumatic pressure converters, valve adjusters in the intake tract region or in the exhaust gas tract of an internal combustion engine can be triggered.

### BACKGROUND OF THE INVENTION

German Patent Disclosure DE 195 00 567.8 discloses an electropneumatic pressure converter. A magnetic force, which is proportional to the control current to which a coil body of a magnet valve is subjected, keeps an armature against a sealing seat that seals off a connection, communicating with the ambient pressure, from a connection to which the consumer pressure is applied. In the currentless state of the magnet valve, the sealing seat is closed. It is a disadvantage that imminent system leaks can occur between a connection that can be subjected to the underpressure and the connection that has the consumer pressure. In the currentless of the magnet valve, a relatively major consumer underpressure is applied to the latter connection.

German Patent Disclosure DE 196 23 960 A1 also relates to an electropneumatic pressure converter. The electropneumatic pressure converter it discloses includes a magnet valve, which has both a magnet coil and an armature that is guided displaceably against a stop that forms a sealing seat. The armature is retained by means of a flexible retainer element. In the currentless state of the magnet coil of the magnet valve, the armature is kept spaced apart from the stop such that an annular gap is created between a region of the electropneumatic pressure converter that can be subjected to the ambient pressure and a region thereof that can be subjected to underpressure. The annular gap can be set by means of the flexibly embodied retaining element. A spring force of the retaining element that keeps the armature horizontal is dimensioned as greater than a spring force, acting vertically on the armature, of a spring element that presses the armature in the direction of the stop.

In the embodiments known from the prior art, a diaphragm component and a valve cap part of a regulator of the electropneumatic pressure converter are embodied as separate components. They are fixed by means of compression springs, which are braced on the housing and cap element of the electropneumatic pressure converter, and by a pressure between the housing and the cap element. The design of the compression springs and the spring properties of the diaphragm component determine the working stroke of the diaphragm cap and of the valve cap in regulated operation of the electropneumatic pressure converter. Both the valve cap and the diaphragm component are produced by the two-component injection molding process. The tool costs are then very high. A further disadvantage of the embodiments known from the prior art is that installing the regulating part in the housing of the electropneumatic pressure converter and installing the associated spring elements is very complex.

### SUMMARY OF THE INVENTION

With the embodiment according to the invention, the regulator part of an electropneumatic pressure converter can be simplified considerably. The functions of the valve cap and of the two-part diaphragm known from the prior art can be taken on by a regulator unit, which includes injection-molded components that are simple to produce and requires only one compression spring element.

Thus by the use of fewer components, on the one hand simple installation of the regulator unit, proposed according to the invention, of an electropneumatic pressure converter and on the other the same functionality of the electropneumatic pressure converter can be realized. The regulator unit includes three components, namely an upper part, an integrally embodied diaphragm component, and a lower part. These components of the regulator unit of an electropneumatic pressure converter can be produced separately in the course of the plastic injection molding process. The aforementioned components of the regulator unit are joined together after being produced in the course of the plastic injection molding process. After the joining operation, the upper and lower part of the regulator unit can be welded to one another by means of a joining method using material engagement, such as ultrasonic welding. In the welding of the upper and lower part of the regulator unit to the integrally embodied diaphragm component, a plurality of sealing points are created in the diaphragm located between them, and these sealing points implement the functionality of the regulator unit of the electropneumatic pressure converter proposed according to the invention. In a preferred feature of the concept that is fundamental to the invention, the regulator unit includes an upper part with a rim that defines a through opening. The integrally embodied diaphragm component likewise includes an annularly embodied rib, forming a rim around the opening, in which rib the upper part can be received. The lower part, which is used in the regulator unit proposed according to the invention, includes a plurality of riblike faces separated from one another by interstices.

Besides the joining method using material engagement, such as ultrasonic welding, a material-engagement connection between the upper part and the lower part of the regulator unit proposed according to the invention for an electropneumatic pressure converter may also be produced in the course of laser welding or other material-engagement methods.

### DRAWING

The invention is described in further detail below in conjunction with the drawing.

Shown are:

FIG. 1, the use of electropneumatic pressure converters for triggering valve adjusters in the intake or exhaust gas tract of internal combustion engines;

FIG. 2, the schematic construction of an electropneumatic pressure converter known from the prior art;

FIG. 2.1, a detail of the regulator unit of an electropneumatic pressure converter known from the prior art, as shown in FIG. 2;

FIGS. 3.1, 3.2, 3.3, the individual parts of a regulator unit proposed according to the invention of an electropneumatic pressure converter;

FIG. 4, a cross section through a regulator unit, joined by means of a material-engagement joining method, including an upper part, an integral diaphragm component, and a lower part; and

FIG. 5, the use of the regulator unit, proposed according to the invention, of FIG. 4 in an electropneumatic pressure converter.

### VARIANT EMBODIMEMTS

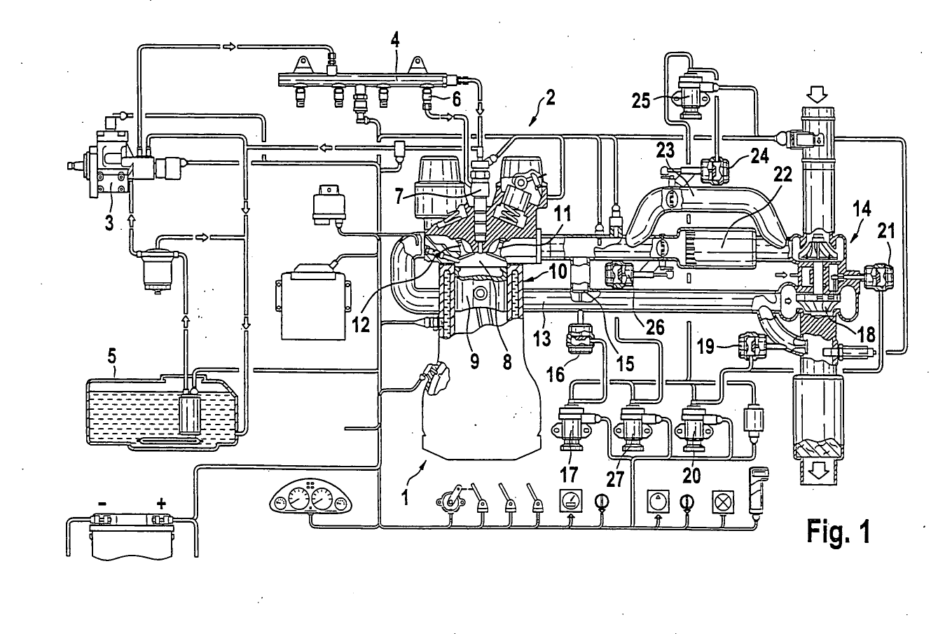

From FIG. 1, the disposition of electropneumatic pressure converters in the intake and exhaust gas tract of an internal combustion engine can be seen. In the view shown in FIG. 1, an internal combustion engine 1 is shown that is supplied with fuel via a high-pressure reservoir 4 (common rail). The cylinder head region of the engine 1 is identified by reference numeral 2; the common rail 4 for receiving fuel is acted upon by fuel pumped via a high-pressure delivery unit 3 from a fuel tank 5. The high-pressure delivery unit 3 subjects the common rail 4 to fuel that is at extremely high pressure.

From the pressure reservoir 4 (common rail), the fuel flows via high-pressure connections 6 to individual fuel injectors 7, provided in a number corresponding to the number of combustion chambers 8 of the engine 1 that are to be supplied with fuel. The fuel injector 7 is disposed in the cylinder head region 2 of the engine 1 in such a way that the injection openings into the combustion chamber 8 are located between inlet valves 11 and outlet valves 12. The outlet valve 12 is adjoined by an exhaust gas line 13, while an intake air line is connected to the inlet valve or valves 11. A charging device 14, which may be embodied as a turbocharger, may be located in the exhaust gas line 13 of the engine 1. An exhaust gas return valve 15 is provided in the exhaust gas line 13 and is actuatable by means of a first adjuster 16. The first adjuster 16 is in turn actuatable via a first electropneumatic converter 17. Via the exhaust gas line 13, exhaust gas flows to an impeller 18 of the charging device 14. Also received in the exhaust gas line 13 is a first charge pressure adjuster 19, with which the charging device 14 is acted upon can be varied. The first charge pressure adjuster 19 is in turn actuatable via a second electropneumatic converter 20. A further, second charge pressure adjuster 21 is furthermore assigned to the charging device 14 and is likewise actuatable via the second electropneumatic converter 20. The impeller 18 of the charging device 14 drives a compressor wheel, with which fresh air is compressed and delivered to a charge air cooler 22. A bypass 23 extends parallel to the charge air cooler 22 in the intake line of the engine and receives a bypass valve adjuster 24, which in turn is actuatable by a third electropneumatic converter 25. Between the outlet side of the charge air cooler 22 and the discharge point of the bypass 23 into the intake line, a regulating valve adjuster 26 is integrated, which in turn is triggered via a fourth electropneumatic converter 27.

The electropneumatic converters 17, 20, 25 and 27 shown in FIG. 1 are often used, as can be seen from the view in FIG. 1, in the intake tract and exhaust gas tract of an internal combustion engine 1. Electropneumatic converters 17, 20, 25 and 27 can also be used for actuating swirl valves and for shutting off the conduit in the intake tube, if pneumatic and proportional adjustment operations become necessary.

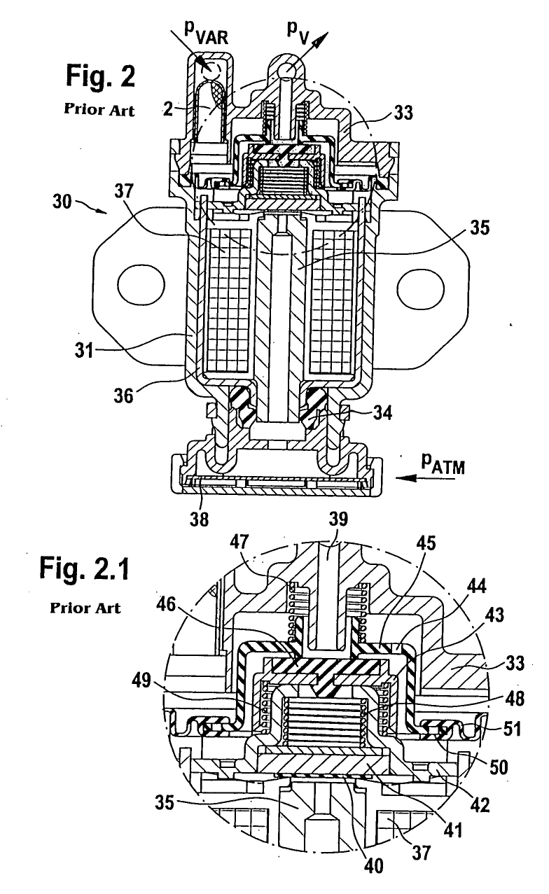

FIG. 2 shows the schematic construction of an electropneumatic converter known from the prior art.

From FIG. 2, it can be seen that the electropneumatic converter 30 shown there includes a housing 31. A disklike filter element 38 is let into the housing 31 in the region of an opening for delivering the atmospheric pressure p_{ATM}. The housing 31 is closed by a cap part 33. A magnet pot 36 is received in the housing 31, and a magnet coil 37 is let into it. The magnet pot 36 is sealed off from the housing 31 on its underside via a seal 34. The magnet coil 37 surrounds a magnet core 35, which has a through bore. A filter element 32 is let into a stub connection in the cap part 33 of the electropneumatic converter 30 of FIG. 2, and a variable consumer underpressure p_{VAR} is applied to this filter element. Also located in the cap part 33 of the electropneumatic converter 30 of FIG. 2 is a connection stub for an underpressure source that furnishes a supply underpressure pᵥ.

The regulator unit of the electropneumatic converter of FIG. 2 can be seen on a larger scale in FIG. 2.1.

The view in FIG. 2.1 shows that a bore 39 is made in the cap part 33. The supply underpressure pᵥ is applied to the bore. The cap part 33 surrounds a first diaphragm component 45, which is joined at a coupling point 50 to a further, second diaphragm component 51. A throttle opening 44 is let into the first diaphragm component 45. Between the inside of the cap part 33 and the neck region of the first diaphragm component 45, there is a first spring element 47. The diaphragm component 45 in turn surrounds a valve cap 43, which is braced on a yoke 42 via a third spring element 49. The yoke 42 is in turn braced by a second spring element 48 above an armature plate 41. The valve cap 43 has a rubber seal 46, on which the neck region of the first diaphragm component 45 is braced. At a coupling point 50, the first diaphragm component 45 and a further, second diaphragm component 51 are joined together. Below the armature plate 41, a rubber plate 40 is received, which is located diametrically opposite a face end of the magnet core 35. The magnet core 35 is in turn surrounded by a magnet coil 37, shown only in part in the detail view of FIG. 2.1.

From the view in FIG. 2.1, it can be seen that the regulator unit shown there requires three spring elements 47, 48, 49 in the upper region of the electropneumatic converter 30 alone, which is very complex to assemble; furthermore, many components are required, that is, diaphragm components 45, 51, the valve cap 43, the rubber seal 46, and the aforementioned springs 47, 48, 49, whose assembly requires a further process that can be automated only with difficulty.

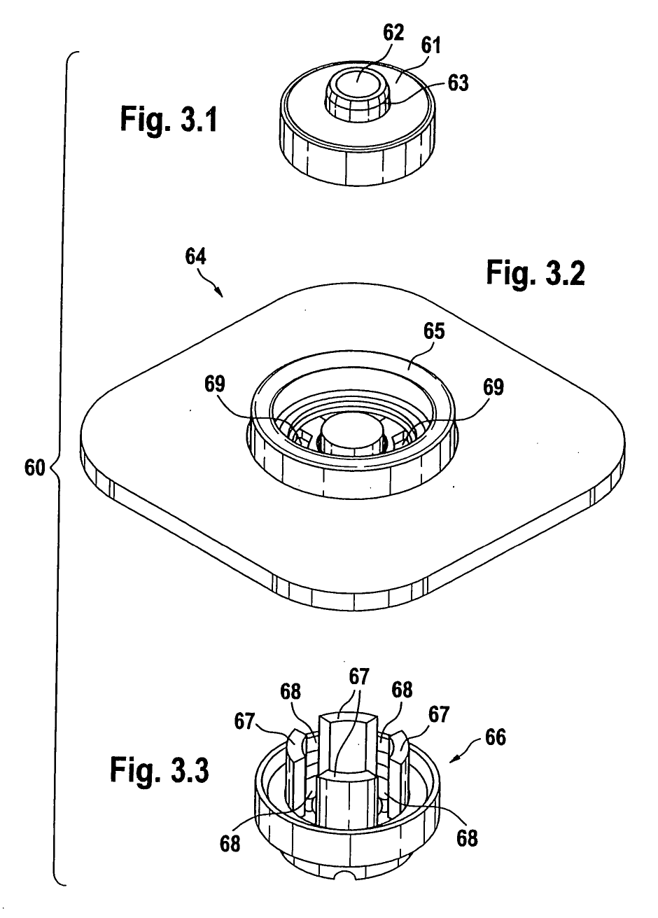

From the views in FIGS. 3.1, 3.2 and 3.3, individual parts of the regulator unit, proposed according to the invention, for an electropneumatic converter can be seen. A regulator unit 60 includes an upper part 61, which has a through opening 62. The through opening 62 is surrounded by a rim 63. FIG. 3.2 shows a diaphragm component 64, embodied integrally and provided with a surface region, and likewise having a rim 65 around an opening on its top. FIG. 3.3 shows a lower part 66 of the regulator unit 60, proposed according to the invention, for an electropneumatic pressure converter; it has a plurality of rib faces 67 separated from one another by interstices 68.

The individual parts, shown in FIGS. 3.1, 3.2 and 3.3, of the regulator unit 60 proposed according to the invention can be made as easily produced injection-molded components, resulting in a regulator unit 60 of simple construction, which requires few components, assures easy installation and guarantees an identical functionality, in comparison to the regulator unit shown in FIGS. 2 and 2.1 that is made up of many individual parts.

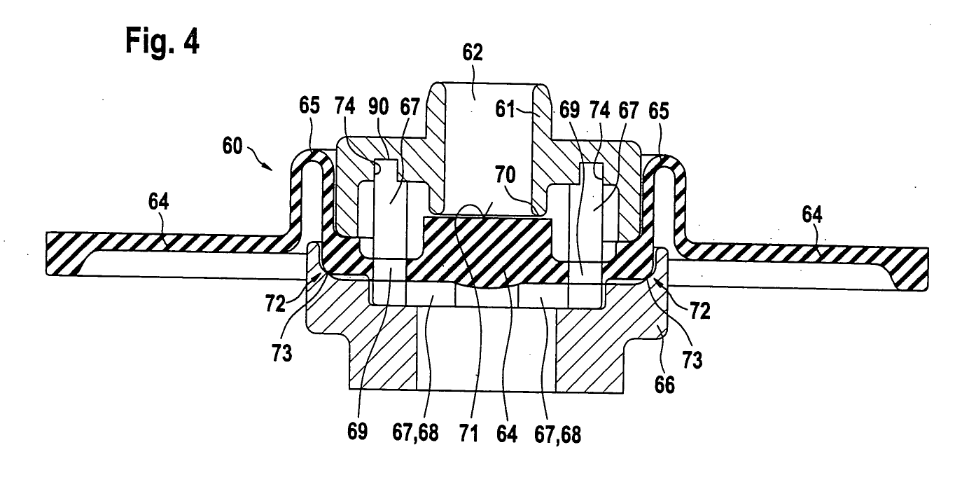

FIG. 4 shows a cross section through a regulator unit joined by material engagement, which includes an upper part, an integral flat diaphragm component, and a lower part.

The view in FIG. 4 shows that the upper part 61 is inserted into the rim 65 in the flat diaphragm component 64. The lower edge of the upper part 61 rests on the base of the rim 65 of the integral diaphragm component 64. The upper part 61 rests on the rib faces 67, which in turn are separated by interstices 68. The rib faces 67 pass through openings 69, not shown in FIG. 4, in the bottom of the diaphragm component 64 that are located inside the rim 65.

The flat integral diaphragm component 64 in turn rests in the lower part 66 of the regulator unit. A sealing region 72 is established between a sealing ring 70 and the diaphragm component 64, forming a linear contact 73. The rib faces 67 pass through openings 69 in the bottom of the diaphragm component 64 and can be connected by material engagement to the underside of the upper part 61 at material-engagement joining points 74, for instance in the course of the ultrasonic welding process.

The integral, flat diaphragm component 64 furthermore has a plane face, identified by reference numeral 71, below the opening 62. A lower rim of the opening 62 together with the plane face 71 of the integral, flat diaphragm component 64 forms a sealing face 70 in the region of the regulator unit 60, whose individual parts are shown in FIGS. 3.1, 3.2, and 3.3.

The rib faces 67, embodied in curved form as shown in FIG. 3.3, reach with their upper ends into an encompassing groove of the upper part 61. The rib face 67 protrude through the openings 69 in the bottom of the diaphragm component 64. This considerably simplifies the joining together of the regulator unit 60 that includes the upper part 61, the integral diaphragm 64 and the lower part 66. Besides the material-engagement joining of the upper part 61 to the lower part 66 with the interposition of the flat, integrally embodied diaphragm component 64 in the course of the ultrasonic welding process, still other material-engagement joining methods may be employed, such as friction welding, laser beam welding, and the like. After the components 61, 64 and 66 of the regulator unit 60 proposed according to the invention have been joined, can after the joining operation be joined by material engagement in automated form to one another, and the material-engagement connecting points 74, because of the diaphragm 64 disposed between the upper part 61 and the lower part 66, create sealing regions 70 and 72, respectively.

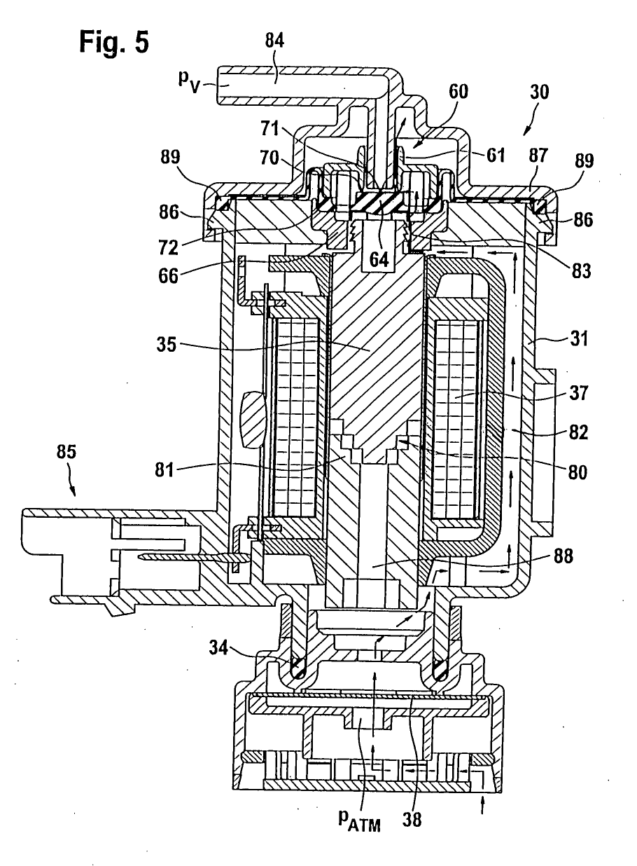

FIG. 5 shows the use of the regulator unit proposed according to the invention, as shown in FIGS. 3.1, 3.2, 3.3, and 4, in an electropneumatic converter.

The electropneumatic converter 30 shown in FIG. 5 includes the housing 31, in which the magnet coil 37 surrounding the magnet core 65 is disposed. The filter insert 38 is located on the underside of the housing 31, above an opening that is at atmospheric pressure p_{ATM}.

The regulator unit 60, including the upper part 61, the integral, flat diaphragm 64, and the lower part 66, is disposed in the upper region of the electropneumatic converter. The upper part 61 of the regulator unit 60 surrounds a stub 84, which is subjected to the supply underpressure pᵥ. Below the integral diaphragm component 64, which is embodied with a spherical region, is the magnet core 35, which is surrounded in turn by an armature guide and the magnet coil 37. The magnet core 35 includes a sawtooth profile 83, with which it passes through the lower part 66 of the regulator unit 60. The integral, flat diaphragm component 64 has fastening points 89 on its outer circumference, and by way of them the diaphragm component 64 is fastened in the housing 31 after a cap element 87 of the electropneumatic converter 30 has been installed.

The magnet core 35 includes a profiling 80, which cooperates with a magnet armature profile 81 of the magnet armature of the electropneumatic converter 30. The magnet armature is penetrated by a through bore 88. The housing 31 of the electropneumatic converter 30 has snap closures 86, on which the cap element 87 can be locked. In the lower region of the housing 31 of the electropneumatic converter 30, there is a plug connection 85 for contacting the magnet coil 37, for instance via a ram contact. The position 85 that marks the electrical interface may for instance be occupied via an FCI plug contact.

It can be seen from FIG. 5 that by the use of a regulator unit 60 proposed according to the invention, containing an upper part 61, a integral, flat diaphragm component 64, and a lower part 66, a considerable simplification of the construction of the regulating region of the electropneumatic pressure converter 30 can be achieved. The components 61, 64 and 66 of the regulator unit 60 may be made as easily produced plastic injection-molded components and placed in the electropneumatic converter 30 before the cap element 87 of the electropneumatic converter is installed. Using the regulator unit 60 proposed according to the invention makes it possible to dispense with use spring elements 47, 48, 49 for prestressing the diaphragm components 45, 51 and for prestressing the valve cap 43, as well as to dispense with separate sealing faces 40, 46 as shown in FIG. 2.1, which shows a regulating region of an electropneumatic converter known from the prior art. Considerable simplification of the assembly of the electropneumatic pressure converter can thus be achieved. Moreover, the spring elements 47, 48 and 49 can now be omitted. In particular, it is now unnecessary to position the first diaphragm component 45 of FIG. 2.1 via the spring element 47 against the rubber seal 47 that is received in the valve cap 43. Sealing between the rubber seal, let into the valve cap 43, and the through bore 39 can be attained by the regulator unit 60 provided according to the invention, by means of the sealing face 70, which is established automatically when the upper part 61 is joined by material engagement to the lower part 66 with the interposition of the integral diaphragm 64 on the plane face 71 of the integral diaphragm component.

As can be seen from the course of the arrow shown in FIG. 5, which indicates the course of the air through the electropneumatic pressure converter 30, the air flows through the opening, which faces toward the atmosphere, via the filter insert 38 into a gap 82, which is embodied between the outside of the magnet coil 37 and the inside of the housing 31. The air flows along the sawtooth profile 83 past the magnet core 35 and along the openings 69 into the chamber above the regulator unit 60.

### LIST OF REFERENCE NUMERALS

1 Internal combustion engine
2 Cylinder head region
3 High-pressure delivery unit
7 Fuel injector
8 Combustion chamber
9 Piston
10 Cylinder
15 Exhaust gas return valve
16 First adjuster
17 First electropneumatic converter
19 First charge pressure adjuster
20 Second electropneumatic converter
21 Second charge pressure adjuster
22 Charge air cooler
23 Bypass line
24 Bypass valve adjuster
25 Third electropneumatic converter
26 Regulating valve adjuster
27 Fourth electropneumatic converter
30 Electropneumatic converter
31 Housing
32 Filter element
33 Cap part
pATM Ambient pressure
34 Seal
35 Magnet core
36 Magnet pot
37 Magnet coil
38 Filter insert
pᵥₐᵣ Mixed pressure
pᵥ Underpressure supply
39 Through bore
40 Rubber plate
41 Armature plate
42 Yoke
43 Valve cap
44 Throttle restriction
45 First diaphragm component
46 Rubber seal
47 First spring element
48 Second spring element
49 Third spring element
50 Coupling point
51 Second diaphragm component
60 Regulator unit
61 Upper part
62 Openings
63 Rim
64 Integral diaphragm component
65 Rim
66 Lower part
67 Rib face
68 Interstice
69 Through openings in diaphragm component (64)
70 Sealing face (in operation)
71 Plane face of diaphragm component (64)
72 Sealing region
73 Linear contact
74 Material-engagement joining point
80 Magnet core profile
81 Magnet armature profile
82 Gap
83 Sawtooth profile
84 Stub
85 Plug connection
86 Snap closure cap element
87 Cap element
88 Through bore
89 Fastening point
90 Encompassing recess

1-10. (canceled)

11. In an electropneumatic pressure converter, having a magnet valve that has a magnet coil and a magnet core, which are received in a housing, and having a regulator unit, with which a variable underpressure p_{VAR} of consumers can be regulated, the improvement wherein the regulator unit comprises components joined together by material engagement, forming sealing points.

12. The electropneumatic converter in accordance with claim 11, wherein said joined-together components of the regulator unit are injection-molded components that can each be produced separately from one another.

13. The electropneumatic converter in accordance with claim 11, wherein the joined-together components are embodied as an upper part, an integral diaphragm component, and a lower part with rib faces.

14. The electropneumatic converter in accordance with claim 13, wherein the rib faces reach through openings in the integral diaphragm component and can be locked on the upper part.

15. The electropneumatic converter in accordance with claim 13, wherein the integral diaphragm component comprises a plane face which, together with a rim of an opening of the upper part, forms a sealing face.

16. The electropneumatic converter in accordance with claim 13, wherein the lower part contacts the integral diaphragm component linearly, forming a sealing region.

17. The electropneumatic converter in accordance with claim 13, wherein the integral diaphragm component comprises a rim bounding its bottom faces, into which rim the upper part is let.

18. The electropneumatic converter in accordance with claim 13, further comprising an encompassing recess embodied on the underside of the upper part, and the rib faces of the lower part that pass through the through openings in the integral diaphragm component engage this recess.

19. The electropneumatic converter in accordance with claim 13, wherein the upper and lower parts are joined by material engagement at joining points in such a way that the integral diaphragm component is located between them.

20. The electropneumatic converter in accordance with claim 13, further comprising an encompassing recess embodied on the underside of the upper part, and the rib faces of the lower part that pass through the through openings in the integral diaphragm component engage this recess, the rib faces of the lower part cooperating with the encompassing recess to form a snap closure on an underside of the upper part.
